(19) United States
(12) Patent Application Publication
(10) Pub. No.: US 2023/0342982 A1
(43) Pub. Date: Oct. 26, 2023

(54) POINT CLOUD CODING DEVICE, POINT CLOUD DECODING DEVICE, POINT CLOUD CODING METHOD, POINT CLOUD DECODING METHOD, AND PROGRAM

(71) Applicants: KDDI Research, Inc., Saitama (JP); University of Southern California, Los Angeles, CA (US)

(72) Inventors: Haoran HONG, Los Angeles, CA (US); Eduardo Hernan Pavez CARVELLI, Los Angeles, CA (US); Antonio ORTEGA, Los Angeles, CA (US); Ryousuke WATANABE, Fujimino-shi (JP); Keisuke NONAKA, Fujimino-shi (JP); Kyouhei UNNO, Fujimino-shi (JP)

(73) Assignees: KDDI Research, Inc., Saitama (JP); University of Southern California, Los Angeles, CA (US)

(21) Appl. No.: 18/097,703

(22) Filed: Jan. 17, 2023

Related U.S. Application Data
(60) Provisional application No. 63/334,680, filed on Apr. 26, 2022.

(51) Int. Cl. G06T 9/00; G06T 3/40; G06T 7/246

(52) U.S. Cl. CPC G06T 9/001; G06T 3/4007; G06T 7/251

(57) ABSTRACT

A point cloud coding device includes an interpolation unit configured to perform an interpolation process on a reconstructed point cloud of a coded frame with respect to attribute information in point cloud information and generating a reference frame of fractional precision, a motion estimation unit configured to perform motion estimation between the reference frame of fractional precision and the frame of integer precision to generate motion information, a prediction unit configured to generate a predicted value on the basis of the motion information, and an entropy coding unit configured to entropy-code the difference between a point cloud of the frame and the predicted value.

### BACKGROUND OF THE INVENTION

### Field of the Invention

The present invention relates to a point cloud coding device, a point cloud decoding device, a point cloud coding method, a point cloud decoding method, and a program.

### Description of Related Art

Since the past, an inter-prediction technique for point clouds as disclosed in Non-Patent Document 1 has been known.

### PATENT DOCUMENTS

[Non-Patent Document 1] “Graph-based compression of dynamic 3D point cloud sequences,” IEEE Transactions on Image Processing, vol. 25, no. 4, pp. 1765-1778, 2016

### SUMMARY OF THE INVENTION

In the conventional method described above, there is a problem in that the motion vector has integer voxel precision and coding efficiency cannot be sufficiently improved.

The present invention was contrived in view of such circumstances, and one object thereof is to improve coding efficiency with respect to attribute information in point cloud information.

(1) According to an aspect of the present invention, there is provided a point cloud coding device including: an interpolation unit configured to perform an interpolation process on a reconstructed point cloud of a coded frame with respect to attribute information in point cloud information and generating a reference frame of fractional precision; a motion estimation unit configured to perform motion estimation between the reference frame of fractional precision and the frame of integer precision to generate motion information; a prediction unit configured to generate a predicted value on the basis of the motion information; and an entropy coding unit configured to entropy-code the difference between a point cloud of the frame and the predicted value.

(2) According to an aspect of the present invention, in the above-described point cloud coding device, the interpolation unit generates an interpolated value by performing an interpolation process on attribute values on the basis of attribute values of two closest points with respect to each fractional precision position.

(3) According to an aspect of the present invention, in the above-described point cloud coding device, in a case where there are two or more of the interpolated values with respect to each fractional precision position, the interpolation unit uses the average value thereof as a final interpolated value.

(4) According to an aspect of the present invention, in the above-described point cloud coding device, the prediction unit uses, as a predicted value, an attribute value of a closest point with respect to each point in the frame of integer precision among points of a reference frame of fractional precision after motion compensation based on the motion information.

(5) According to an aspect of the present invention, in the above-described point cloud coding device, the fractional precision is ½ voxel precision.

(6) According to an aspect of the present invention, there is provided a point cloud decoding device including: an interpolation unit configured to perform an interpolation process on a reconstructed point cloud of a decoded frame with respect to attribute information in point cloud information and generate a reference frame of fractional precision; an entropy decoding unit configured to decode motion information and a predicted residual from a bit stream; a prediction unit configured to generate a predicted value on the basis of the motion information and the reference frame of fractional precision; and an attribute information decoding unit configured to use the sum of the predicted residual and the predicted value as the decoding value of an attribute value.

(7) According to an aspect of the present invention, in the above-described point cloud decoding device, the interpolation unit generates an interpolated value by performing an interpolation process on attribute values on the basis of attribute values of two closest points with respect to each fractional precision position.

(8) According to an aspect of the present invention, in the above-described point cloud decoding device, in a case where there are two or more of the interpolated values with respect to each fractional precision position, the interpolation unit uses the average value thereof as a final interpolated value.

(9) According to an aspect of the present invention, in the above-described point cloud decoding device, the prediction unit uses, as a predicted value, an attribute value of a closest point with respect to each point in the frame of integer precision among points of a reference frame of fractional precision after motion compensation based on the motion information.

(10) According to an aspect of the present invention, in the above-described point cloud decoding device, the fractional precision is ½ voxel precision.

(11) According to an aspect of the present invention, there is provided a point cloud coding method including: performing an interpolation process on a reconstructed point cloud of a coded frame with respect to attribute information in point cloud information and generating a reference frame of fractional precision; performing motion estimation between the reference frame of fractional precision and the frame of integer precision to generate motion information; generating a predicted value on the basis of the motion information; and entropy-coding the difference between a point cloud of the frame and the predicted value.

(12) According to an aspect of the present invention, there is provided a program for causing a computer included in a point cloud coding device to execute: performing an interpolation process on a reconstructed point cloud of a coded frame with respect to attribute information in point cloud information and generating a reference frame of fractional precision; performing motion estimation between the reference frame of fractional precision and the frame of integer precision to generate motion information; generating a predicted value on the basis of the motion information; and entropy-coding the difference between a point cloud of the frame and the predicted value.

(13) According to an aspect of the present invention, there is provided a point cloud decoding method including: performing an interpolation process on a reconstructed point cloud of a decoded frame with respect to attribute information in point cloud information and generating a reference frame of fractional precision; decoding motion information and a predicted residual from a bit stream; generating a predicted value on the basis of the motion information and the reference frame of fractional precision; and using the sum of the predicted residual and the predicted value as the decoding value of an attribute value.

(14) According to an aspect of the present invention, there is provided a program for causing a computer included in a point cloud decoding method to execute: performing an interpolation process on a reconstructed point cloud of a decoded frame with respect to attribute information in point cloud information and generating a reference frame of fractional precision; decoding motion information and a predicted residual from a bit stream; generating a predicted value on the basis of the motion information and the reference frame of fractional precision; and using the sum of the predicted residual and the predicted value as the decoding value of an attribute value.

According to the present invention, it is possible to improve coding efficiency for attribute information in point cloud information.

### BRIEF DESCRIPTION OF THE DRAWINGS

FIG. 1A is a diagram illustrating all candidates for the positions of integer voxels and ½ voxels in the present embodiment.

FIG. 1B is a diagram illustrating a first example of fractional voxels obtained from adjacent integer voxels in the present embodiment.

FIG. 1C is a diagram illustrating a second example of fractional voxels obtained from adjacent integer voxels in the present embodiment.

FIG. 1D is a diagram illustrating a third example of fractional voxels obtained from adjacent integer voxels in the present embodiment.

FIG. 2 is a diagram illustrating an example of comparison between an original block and a super-resolved reference block.

FIG. 3 is a diagram illustrating an example of motion compensation prediction of the present embodiment.

FIG. 4A is a diagram illustrating an example of a rate distortion curve for a first data set (longdress).

FIG. 4B is a diagram illustrating an example of a rate distortion curve for a second data set (soldier).

FIG. 4C is a diagram illustrating an example of a rate distortion curve for a third data set (redandblack).

FIG. 4D is a diagram illustrating an example of a rate distortion curve for a fourth data set (loot).

FIG. 5 is a diagram illustrating BD rate performance relative to a baseline of the present embodiment.

FIG. 6 is a diagram illustrating a point cloud processing system according to an embodiment of the present embodiment.

FIG. 7 is a diagram illustrating an example of a functional block of a point cloud coding device according to the present embodiment.

FIG. 8 is a diagram illustrating an example of a functional block of an attribute information coding unit according to the present embodiment.

FIG. 9 is a diagram illustrating an example of a functional block of a motion estimation unit.

FIG. 10 is a diagram illustrating an example of a functional block of a point cloud decoding device according to the present embodiment.

FIG. 11 is a diagram illustrating an example of a functional block of an attribute information decoding unit according to the present embodiment.

### DETAILED DESCRIPTION OF THE INVENTION

Abstract

Motivated by the success of fractional pixel motion in video coding, we explore the design of motion estimation with fractional-voxel resolution for compression of color attributes of dynamic 3D point clouds. Our proposed block-based fractional-voxel motion estimation scheme takes into account the fundamental differences between point clouds and videos, i.e., the irregularity of the distribution of voxels within a frame and across frames. We show that motion compensation can benefit from the higher resolution reference and more accurate displacements provided by fractional precision.

Our proposed scheme significantly outperforms comparable methods that only use integer motion. The proposed scheme can be combined with and add sizeable gains to state-of-the-art systems that use transforms such as Region Adaptive Graph Fourier Transform and Region Adaptive Haar Transform.

1 Introduction

Recent progress in 3D acquisition and reconstruction technology makes the capture of 3D scenes ubiquitous. In dynamic point clouds, each frame consists of a list of data points with 3D coordinates and RGB color values. Since point clouds in raw format would require a huge amount of bandwidth for transmission there has been a significant interest in point cloud compression techniques, which has led to MPEG standardization efforts, considering both video-based point cloud compression (VPCC) and geometry-based point cloud compression (G-PCC).

Methods for inter-frame (temporal) prediction have been proposed to achieve efficient compression of dynamic point clouds. These methods can be grouped into three main categories. In voxel-based schemes, where a motion vector (MV) is estimated for each voxel, a few points in both the prediction and reference frames are selected as anchors to establish correspondence via spectral matching, leading to a set of sparse MVs. Then, using a smoothness constraint, a dense set of MVs can be obtained from the sparse set to provide motion for all remaining points. In patch-based techniques, motion estimation (ME) is considered as an unsupervised 3D point registration process wherein a MV is estimated by iterative closest point (ICP) for each patch generated by K-means clustering. In this paper we focus on block-based methods, where frames to be predicted are partitioned into several non-overlapping This work was funded in part by KDDI Research, Inc. and by the National Science Foundation (NSF CNS-1956190). 3-dimensional blocks of a given size. For each block, the best matching block in a reference frame is selected according to specific matching criteria, which can be based purely on geometry, e.g., an ICP-based approach that generates rigid transforms, or can use a combination of geometry and color attribute information. Recent work has also focused on block-based motion search speedup, including both efficient search pattern design and search window reduction.

Our work is motivated by the observation that ME with sub-pixel accuracy is an essential tool for modern video coding, while all the aforementioned ME methods for dynamic point clouds are based on integer-voxel displacements. There are two main reasons why a direct extension of video-based fractional ME to 3D contexts is not straightforward. First, point clouds are irregularly distributed within each frame, i.e., only those voxels that correspond to the surfaces of objects in the scene contain attribute information. Thus, while interpolation of attributes at new voxel locations can be based in conventional methods, we have the additional challenge of choosing only those new voxel locations that are consistent with object surfaces, even though those surfaces are not explicitly known. For example, we would like to avoid creating additional, fractional accuracy voxels inside an object. Second, voxels are inconsistent across frames, i.e., both the number of voxels and their distribution in space are different from frame to frame. Thus, since two matching blocks in consecutive frames will in general have a different number of voxels containing attribute information, we will need to develop alternatives to the one-to-one pixel (or sub-pixel) matching commonly used for conventional video.

In this paper, we focus on fractional-voxel motion estimation (FvME) under the assumption that integer-voxel MVs (IvMVs) have already been obtained using an existing integer-voxel motion estimation (IvME) scheme. Specifically, in this paper we use precomputed IvMVs from a public database. In our approach, we start by creating fractional voxels between pairs of neighboring occupied integer voxels. Neighboring voxels are used to favor consistency with object surfaces, without requiring explicit estimation of the surfaces. Then, a higher resolution point cloud is obtained by interpolating attributes at each fractional voxel from the values at nearby integer voxels. FvME is implemented by searching fractional-voxel MVs (FvMVs) around the positions given by IvMVs and selecting the fractional displacement leading to the lowest motion compensation prediction error. Motion-compensated prediction is implemented by directly copying, as the attribute for a voxel in a block in the current frame, the attribute of the nearest voxel in the matched blocked in the reference frame. Our proposed FvME scheme leads to improved performance over transform based approaches without inter or intra prediction and is also significantly better than temporal prediction methods based on the IvMVs from the public database.

2 Fractional-Voxel Motion Estimation and Compensation

2.1 Motivation

Real-world scenes and objects are captured by multiple calibrated and synchronized RGB or RGB-D cameras clusters from various viewing angles. After stitching and voxelization, dynamic point clouds are generated on integer grids. Note that the 3D voxel coordinates are obtained as integer approximations to the “true” positions of the object in 3D space, while the optimal displacement between frames is unlikely to be exactly integer. Thus, a fractional voxel displacement can be better than an integer-one, so that higher resolution MVs have the potential to provide more accurate motion and hence more accurate MC prediction. Furthermore, distortion due to lossy coding in previously reconstructed point cloud frames can lead to higher prediction errors, while camera noise, lighting change in the capture environment, object movements, etc., may also result in noisy color attributes and in imperfect matches during motion search. Thus, as for conventional video, where it is well known that fractional motion compensation contributes to noise removal, the process of generating higher resolution point clouds and attributes at fractional voxel locations can contribute to denoising and lead to improvements in the quality of the reference frames.

2.2 Occupied Fractional Voxels

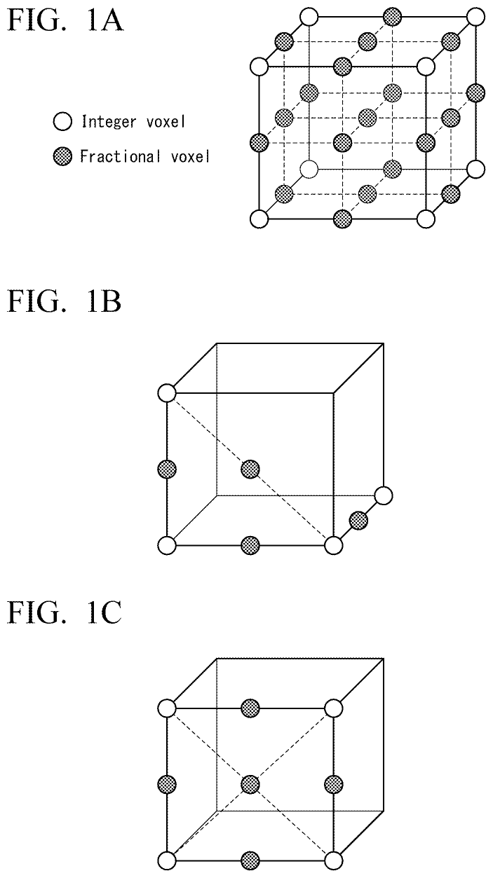

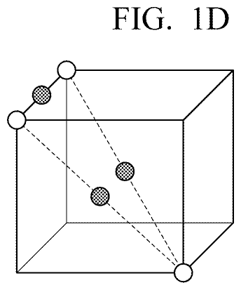

In this section, we define fractional voxels and describe our proposed method for interpolation. Based on the same design philosophy used for images and videos, fractional voxels are created at selected intermediate locations between voxels on the integer resolution grid. We define a fractional voxel of ½ resolution (½-voxel), as a voxel at the mid point between any two neighboring integer-voxels. As noted in the introduction, not all integer-voxels are “occupied” in 3D space, and those that are occupied typically correspond to object surfaces. Thus, in our proposed method, new fractional voxels are created only at locations in 3D space that are (approximately) consistent with the surfaces implied the location of occupied integer voxels and attributes are interpolated only at these newly created fractional voxels. We say that two integer voxels with coordinates vj and vk are neighbors if their distance is below a threshold p. Then, a fractional voxel is created only between neighbors vj and vk (assumed to be close enough so that they are likely to belong to the same surface) and the corresponding interpolated color attribute is computed as:

$$C ( {v}_{i} ) = \frac{1}{2} ( C ( {v}_{j} ) + C ( {v}_{k} ) ) , \qquad [ Equation 1 ]$$

$$with L ( {v}_{i} ) = \frac{1}{2} ( L ( {v}_{j} ) + L ( {v}_{k} ) ) and dist ( {v}_{j} , {v}_{k} ) \leq ρ , {v}_{j} , {v}_{k} ∈ {V}_{i} ,$$

where vi is a voxel in the fractional-voxel set Vf with color signal C(vi), vj and vk are voxels in the integer-voxel set Vi with color signal C(vj) and C(vk), respectively. L(⋅) represents the coordinates of the voxel. ρ is the distance threshold and dist(vj, vk) measures the Euclidean distance between the coordinates of vj and vk. Note that different pairs of integer voxels may produce the same fractional voxel. Thus, to remove repeated fractional voxels after interpolation, attributes that belong to the same fractional voxel and are obtained by interpolation from different pairs of neighboring voxels are merged by averaging. FIG. 1B shows several examples of possible fractional-voxels locations, where we can see that interpolation based on neighboring integer voxels tends to favor increasing the voxel resolution on the (implicit) surface where the voxels are located.

FIG. 1A-1D: Integer and fractional voxels. FIG. 1a depicts all possible candidate integer and ½-voxels positions FIG. 1b shows 3 examples of occupied integer voxel positions with corresponding fractional voxels obtained from neighboring integer voxels. Note that these interpolated fractional voxels are more likely to belong to the same surface as the neighboring integer voxels they were obtained from.

2.3 ME with Fractional-Voxel Accuracy

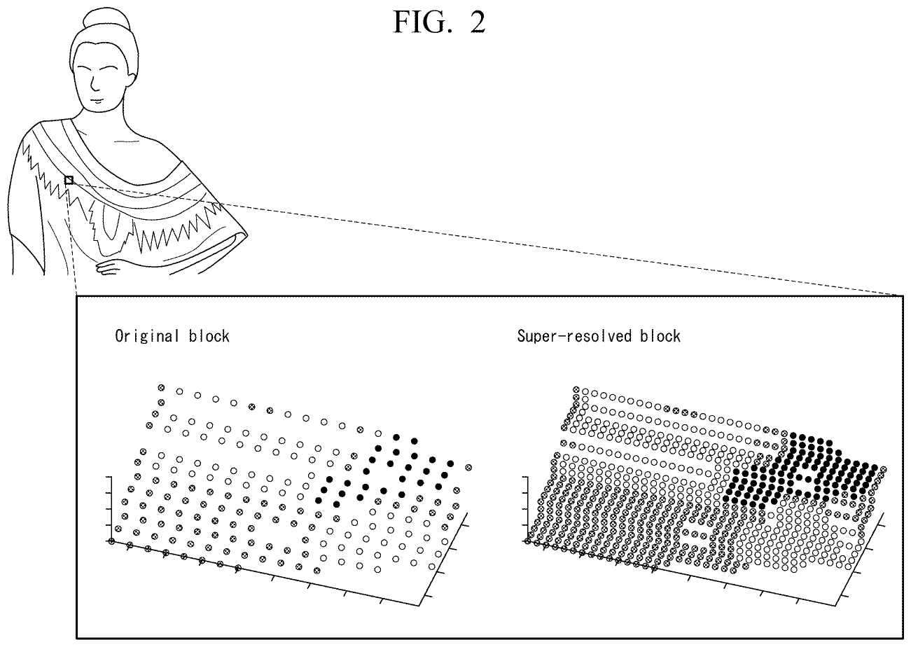

Due to the inconsistency of voxel distributions in consecutive frames, it is difficult to establish exact one-to-one correspondences between the voxels in two matching blocks. To generalize MC prediction for fractional motion in 3D space, we start by super-resolving the reference frame as described in Section 2.2. As we can see from FIG. 2, the continuity among voxels and their corresponding attributes is significantly increased underlying surfaces, which provide better predictors when high resolution motion is available. The low pass filtering used for interpolation also contributes to attribute noise removal.

FIG. 2: Comparison between the original and super-resolved reference block.

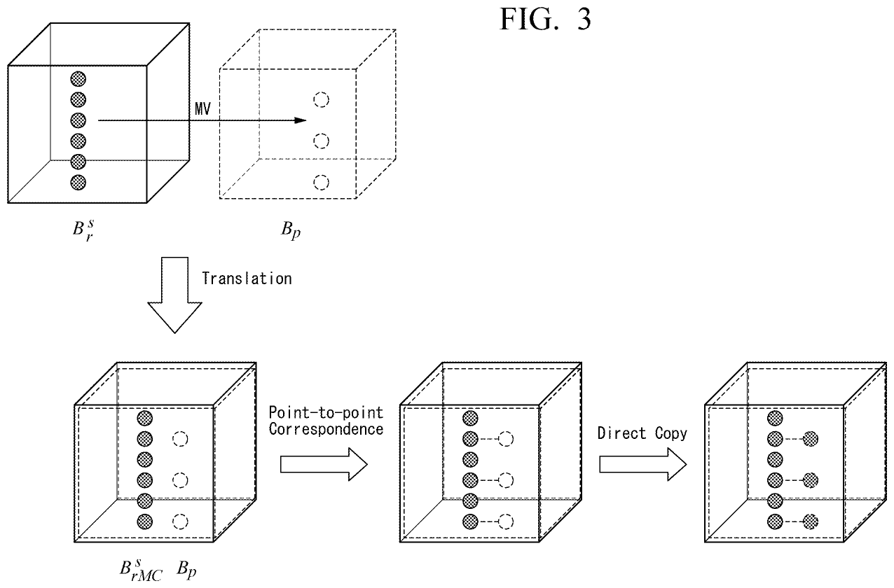

Next, we estimate MVs in fractional precision for MC. The entire ME process is a coarse-to-fine procedure, including IvME and FvME. Each estimated MV is obtained as the sum of an IvMV and a FvMV displacement. Assuming the IvMV MVi is given, the optimal FvMV MV opt f is searched from a set of candidate fractional displacements. Since we super-resolve the reference frame in ½-voxel precision, each coordinate of a fractional displacement MVf can take values in {−½, 0, ½}, resulting in 27 possible displacements. For a given fractional displacement MVf, we predict each attribute in the current block from its nearest voxel in the translated super-resolved reference block, as depicted in FIG. 3. Then the displacement with the smallest prediction error is chosen, that is,

$$\begin{matrix}{MV}_{f}^{opt} = arg {min}_{{MV}_{f}} {\sum }_{{v}_{i} ∈ V ( {B}_{v} )} {E}_{pred} ( C ( {v}_{i} ) , C ( {v}_{j} ) ) , \\ s . t . {j}^{′} = arg {min}_{j} ( dist ( {v}_{i} , {v}_{j} ) ) , {v}_{j} ∈ V ( {B}_{rMC}^{s} ) , \\ {L}_{b} ( {B}_{rMC}^{s} ) = {L}_{b} ( {B}_{r}^{s} ) + MV , \\ MV = {MV}_{f} + {MV}_{i} ,\end{matrix} \qquad [ Equation 2 ]$$

where Bs r and Bs rMC represent the super-resolved reference block before and after translation with MV, respectively, vi and vj are voxels with color signals C(vi) and C(vj) in blocks Bp and Bs rMC, respectively. Epred(⋅, ⋅) is the function for measuring the prediction error. Lb(⋅) represents the coordinates of the block while V(⋅) represents the set of voxels within the block.

FIG. 3: Motion-compensated prediction.

2.4 MC Prediction with Fractional-Voxel Accuracy

Finally, we apply MC prediction using the obtained MVs in fractional precision. Specifically, once the voxels in the reference block are translated using the integer motion vector MVi, they are further shifted by the obtained optimal fractional displacement MV opt f, as shown in (2). Then, temporal correspondence are established from voxels in the predicted block Bp to their nearest neighbours in the translated super-resolved reference block Bs rMC for motion-compensated prediction. The attribute of each voxel in the predicted block is predicted by copying the attribute of its corresponding voxel in the reference frame, that is,

$$∀ {v}_{i} ∈ {B}_{p} , C ( {v}_{i} ) = C ( {v}_{{j}^{′}} ) s . t . {j}^{′} = arg {min}_{j} ( dist ( {v}_{i} , {v}_{j} ) ) , {v}_{j} ∈ {B}_{rMC}^{s} . \qquad [ Equation 3 ]$$

3 Experiments

3.1 Dataset

In this section, we evaluate the proposed FvME scheme for compression of color attributes of a known dataset, which consists of four sequences: longdress, redandblack, loot and soldier. Each sequence contains 300 frames.

Note that we assume IvMVs are given and are used to estimate FvMVs. Since IvMVs derived using different algorithms may lead to different FvMVs with disparate coding performance, we start from the publicly available 3D motion vector database. The IvMVs in the database are selected to minimize a hybrid distance metric, δ=δg+0.35δc, which combines δg, the average Euclidean distance between the voxels, and δc, the average color distance in Y-channel1. We only consider motion for 16×16×16 sized blocks. We implement a conventional inter-coding system where previously decoded frames are used as reference.

3.2 Experimental Settings

Following the MPEG Call for Proposal (CfP) for point cloud compression, we evaluate the proposed block-based FvME scheme (Proposed FvME) in groups of 32 frames, with the first frame coded in intra mode, and the rest coded using inter prediction. The threshold distance between integer voxels for interpolating fractional voxels is set to ρ=√3 in (1). Colors are transformed from RGB to YUV spaces, and each of the Y, U, and V channels are processed independently. When searching for the best candidate FvMV in (2), we use the squared distances to measure prediction errors. All blocks in the intra-coded frames undergo region adaptive graph Fourier transform (RA-GFT) while, in the inter-coded frames, all blocks are motion-compensated. After MC prediction, the residues are transformed using the graph Fourier transform (GFT). To compute the GFT, a threshold graph is built inside every block wherein voxels are connected to each other if their Euclidean distance is less than or equal to √3. If after thresholding, the resulting graph for a block is not connected, a complete graph is built instead, which results in the transformed coefficients consisting of a single approximation coefficient (DC) and multiple detail coefficients (AC) for each block. The DC coefficients of all blocks are concatenated and encoded together. Then, the AC coefficients are coded block by block. This approach is equivalent to a single level RA-GFT. For all transforms, we perform uniform quantization and entropy code the coefficients using the adaptive run-length Golomb-Rice algorithm (RLGR). As for FvMVs overheads, since there are 27 FvMVs in total, 8 bits are used to signal each FvMV. For IvMVs, we use 4 bits to signal the value and 1 bit to signal sign for each axis and therefore, 15 total bits are used to represent an IvMV. The overheads of FvMVs and IvMVs are entropy coded by Lempel-Ziv-Markov chain algorithm.

We considered the following schemes as baselines. IvME using the database motion (DM) for MC prediction and using DM with additional integer local refinement (DM+RF) for MC prediction. The local refinement uses different criteria that aims 1Note that the resulting IvMVs aim to select matching blocks with similar geometry (δg) and color attributes (δc) but there is no guarantee that this metric, and in particular the relative weight between the distances (0.35) is the optimal choice in terms of coding efficiency. Thus, it will be shown in our motion compensation experiments, that these IvMVs can sometimes lead to performance below that of encoding methods that do not use motion compensation. In these cases performance can be improved by local refinement of the IvMVs from the database. to minimize color errors only, instead of the hybrid errors used in the database. DM is refined by additional local search in integer precision to improve its matching accuracy over the original ones. The locally refined range for each axis is set to be[−1, 1], which entirely encloses fractional positions searched in the proposed FvME scheme.

To evaluate the benefits of high resolution references and FvMVs, we propose two inter coding schemes which are using super-resolved reference blocks, with and without fractional motion vectors for compensated prediction. First, to evaluate the super-resolution method, we implement a scheme that considers IvME using integer local refined DM and super-resolved reference blocks for prediction, which is denoted by “DM+RF+SR.” The difference between DM+RF and DM+RF+SR is the resolution of the reference block. Then, to evaluate benefits of FvMVs, we implement a scheme that uses fractional resolution in both reference blocks and motion vectors, which is denoted by “proposed FvME.” For a fair comparison between inter coding schemes, all other test conditions are the same.

Additionally, to make our performance evaluation more complete, we include two state of the art (all intra) anchor solutions, namely, RA-GFT and region adaptive Haar transform (RAHT). For RA-GFT, block size 16 is used. The residues are entropy coded by RLGR.

3.3 Evaluation Metrics

The evaluation metrics are the number of bits per voxel (bpv) and average peak signal-to-noise ratio over Y component (PSNR-Y),

$${PSNR}_{v} = - 10 {log}_{10} ( \frac{1}{T} {\sum }_{t = 1}^{T} \frac{{‖ {Y}_{t} - {\hat{Y}}_{t} ‖}_{2}^{2}}{{255}^{2} {N}_{t}} ) , bpv = \frac{{\sum }_{t = 1}^{T} {b}_{t}}{{\sum }_{t = 1}^{T} {N}_{t}} , \qquad [ Equation 4 ]$$

where Yt and Y\hat{ }t represent original and reconstructed signals on the same voxels of t-th frame respectively, T is the total number of frames, bt is the bits required to encode YUV components of t-th, including IvMVs and FvMVs overhead when necessary, and Nt is the total number of occupied voxels in t-th frame. The Bjontegaard-Delta results for bitrate (BD-rate) are also reported.

3.4 Experimental Results and Analysis

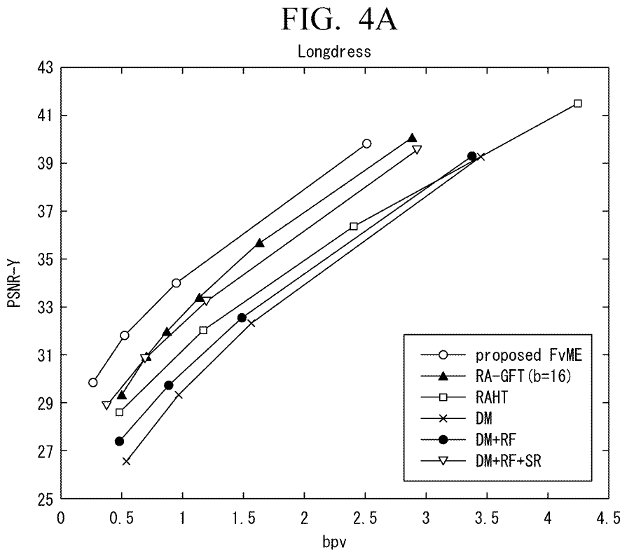

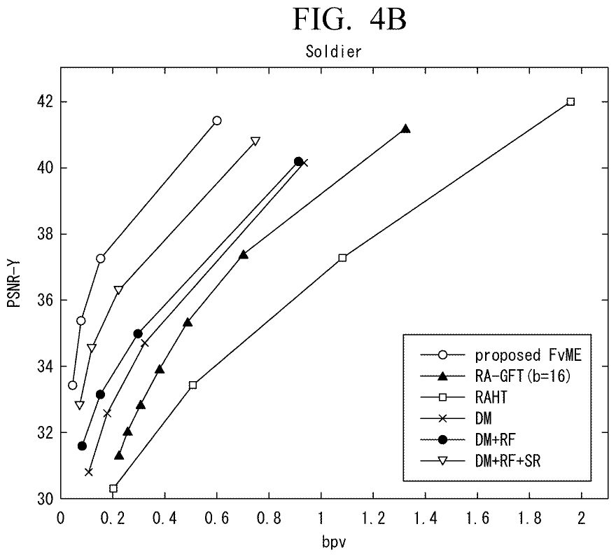

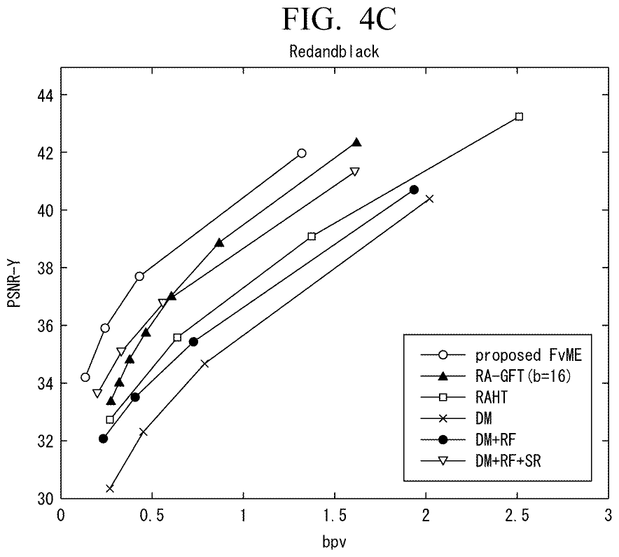

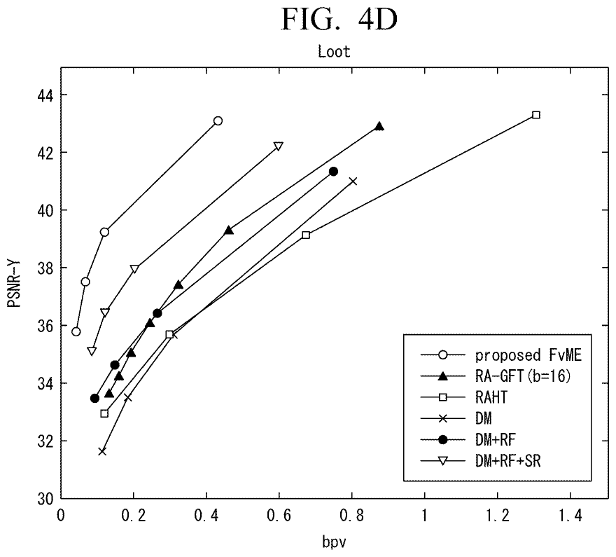

Rate distortion (RD) curves are shown in FIG. 4. We first note that using only the original IvME from the database, results in sub-optimal performance compared to RAHT and RA-GFT. This is in part due to the criteria used in the database to choose the optimal MV based on geometry and color information. After local refinement with integer precision, the performance of IvME (DM+RF) improves significantly with respect to IvME (DM) but it is still far from being competitive with other techniques. Further improvements have been shown to be achievable by using per block intra/inter mode decision.

FIG. 4A-4D: Rate distortion curves of 8iVFBv2 sequences.

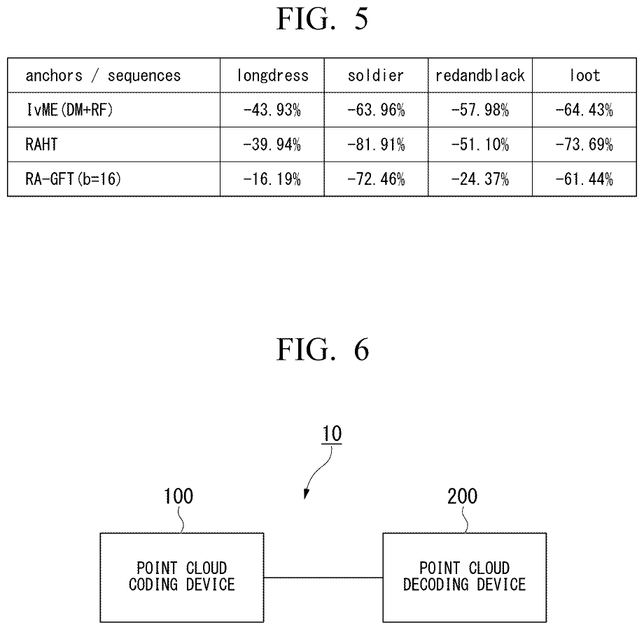

FIG. 5: The BD-rate performances of the proposed scheme over baselines

After the reference blocks are super-resolved, the performance of the proposed IvME (DM+RF+SR) is further improved with respect to DM+RF, even without increasing MV resolution. The DM+RF+SR scheme can be better than the intra schemes in some cases with the advantage of complexity lower than that of the proposed FvME. Finally, after we increase MV resolution to ½-voxel, further coding gains are obtained, outperforming intra coding baselines, RA-GFT and RAHT, with average gains of 2.8 dB and 4.6 dB, respectively. The method is always better than DM+RF+SR but at the cost of higher complexity due to additional motion search. The results show that both interpolated fractional voxels and high resolution MVs lead to higher coding gain and outperform both inter coding with IvME and non predictive transform based schemes.

FIG. 5 summarizes the performance of the proposed method over IvME (DM+RF), RA-GFT, and RAGT in terms of BD-rate. The proposed FvME can achieve 57% average bitrate reduction over IvME (DM+RF). Compared with the prior arts, the proposed scheme can achieve 61% and 43% bitrate reduction on average over RAHT and RA-GFT respectively.

### EMBODIMENT

Hereinafter, specific examples of an embodiment of the present invention will be described with reference to the accompanying drawings. Meanwhile, components in the following embodiment can be appropriately replaced with existing components and the like, and various variations including combinations with other existing components are possible. Therefore, the following description of the embodiment is not intended to limit the content of the invention described in the claims.

### First Embodiment

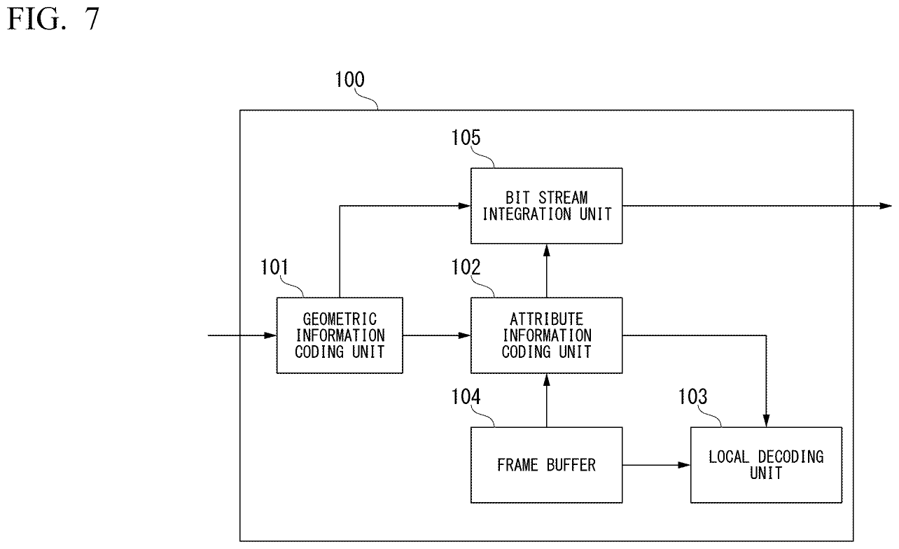

Hereinafter, a point cloud processing system 10 according to a first embodiment of the present invention will be described with reference to FIGS. 6 to 7.

FIG. 6 is a diagram illustrating the point cloud processing system 10 according to the embodiment of the present embodiment. As shown in FIG. 6, the point cloud processing system 10 includes a point cloud coding device 100 and a point cloud decoding device 200.

The point cloud coding device 100 is configured to generate coded data (bit stream) by coding an input point cloud signal. The point cloud decoding device 200 is configured to generate an output point cloud signal by decoding the bit stream.

Meanwhile, the input point cloud signal and the output point cloud signal are constituted by position information and attribute information of each point within a point cloud. The attribute information is, for example, color information or reflectance of each point.

Here, such a bit stream may be transmitted from the point cloud coding device 100 to the point cloud decoding device 200 through a transmission line. In addition, the bit stream may be stored in a storage medium and then provided from the point cloud coding device 100 to the point cloud decoding device 200.

### (Point Cloud Coding Device 100)

Hereinafter, the point cloud coding device 100 according to the present embodiment will be described with reference to FIG. 7.

FIG. 7 is a diagram illustrating an example of a functional block of the point cloud coding device 100 according to the present embodiment. As shown in FIG. 7, the point cloud coding device 100 includes a geometric information coding unit 101, an attribute information coding unit 102, a local decoding unit 103, a frame buffer 104, and a bit stream integration unit 105.

In some cases, “geometric information” is referred to simply as “geometry”.

The geometric information coding unit 101 performs a coding process on geometric information using a point cloud to be coded as an input, and outputs a bit stream of the geometric information to the bit stream integration unit 105. Here, a method of coding the geometric information can be realized by a known method such as, for example, G-PCC, and thus the details thereof will be omitted. In addition, a local decoding process of the geometric information is executed to generate a reconstructed point cloud based on the geometric information obtained on the decoding side. At this time, in a case where the geometric information does not completely match between the point cloud to be coded and the reconstructed point cloud, attribute information of each point within the reconstructed point cloud (hereinafter, RGB color information will be described as an example) is generated on the basis of color information of the point cloud to be coded. That is, the attribute information is information indicating an attribute (for example, color) of each point in a point cloud.

For example, a point with the smallest Euclidean distance among the points of the point cloud to be coded may be specified for each point in the reconstructed point cloud, and the color information of the point may be used as it is. Alternatively, K neighboring points in the point cloud to be coded may be specified and calculated from the neighboring points using an interpolation process. The reconstructed point cloud generated in this way is output to the attribute information coding unit 102.

The attribute information coding unit 102 uses the reconstructed point cloud of the frame output from the geometric information coding unit 101 and the reconstructed point cloud of the coded frame stored in the frame buffer 104 as inputs, codes the attribute information of the frame, and outputs a bit stream of the attribute information to the bit stream integration unit 105. In addition, data required for local decoding is output to the local decoding unit 103. The data required for local decoding is, for example, a set of the geometric information of the reconstructed point cloud which is output from the geometric information coding unit and the value of the bit stream generated by the attribute information coding unit 102 or a coding symbol (syntax element) immediately before conversion into the bit stream through entropy coding. The details of processing of the attribute information coding unit 102 will be described later.

The local decoding unit 103 uses the data required for local decoding which is output from the attribute information coding unit 102 as an input, locally decodes the frame to generate a reconstructed point cloud of the frame, and outputs the reconstructed point cloud to the frame buffer 104. The reconstructed point cloud of the frame obtained here is exactly the same as the reconstructed point cloud obtained by the point cloud decoding device 200.

The frame buffer 104 stores the reconstructed point cloud of the frame which is output from the local decoding unit 103 and outputs the stored reconstructed point cloud to the attribute information coding unit 102 during the coding process of a frame which is coded after the frame.

### (Attribute Information Coding Unit 102)

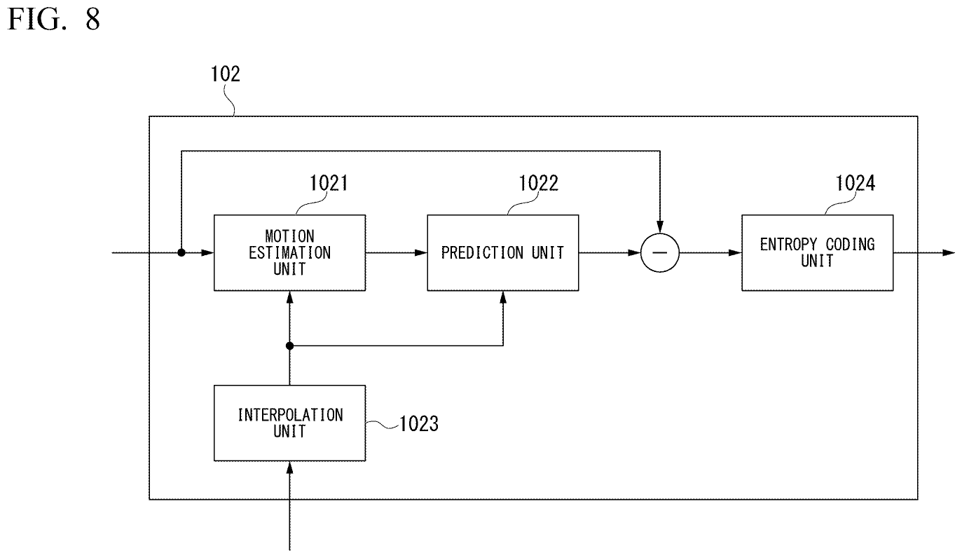

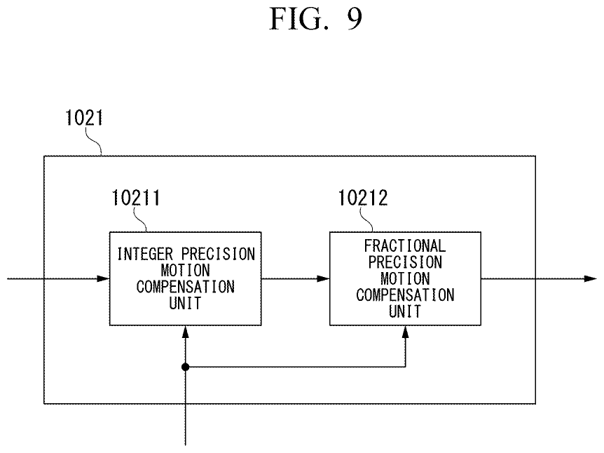

Hereinafter, the attribute information coding unit 102 according to the present embodiment will be described with reference to FIGS. 8 and 9.

FIG. 8 is a diagram illustrating an example of a functional block of the attribute information coding unit 102 according to the present embodiment. As shown in FIG. 8, the attribute information coding unit 102 includes a motion estimation unit 1021, a prediction unit 1022, an interpolation unit 1023, and an entropy coding unit 1024.

The motion estimation unit 1021 uses the reconstructed point cloud of the frame output from the geometric information coding unit 101 and the reconstructed point cloud of the reference frame at a fractional precision position interpolated by the interpolation unit 1023 as inputs, performs motion compensation, and outputs motion information. Here, the reference frame is an already coded frame stored in the frame buffer 104. In addition, the motion information is, for example, a motion vector calculated for each region of a predetermined size.

Hereinafter, an example of processing of the motion estimation unit 1021 will be described with reference to FIG. 9.

FIG. 9 is a diagram illustrating an example of a functional block of the motion estimation unit 1021.

An integer precision motion estimation unit 10211 uses the reconstructed point cloud of the frame output from the geometric information coding unit 101 and the reconstructed point cloud of the reference frame at a fractional precision position interpolated by the interpolation unit 1023 as inputs, performs motion estimation with integer position precision, and calculates motion information. This motion information is, for example, a motion vector with integer precision calculated for each region of a predetermined size (for example, 16×16×16). A specific motion compensation method can be realized using a known method, and thus the details thereof will be omitted.

In the following description, the value of the fractional precision position calculated by the interpolation operation is also referred to as an interpolated value.

A fractional precision motion estimation unit 10212 uses the reconstructed point cloud of the frame output from the geometric information coding unit 101, the reconstructed point cloud of the reference frame at a fractional precision position interpolated by the interpolation unit 1023, and the motion vector of integer precision derived by the integer precision motion estimation unit 10211 as inputs, performs motion compensation of fractional precision, and generates motion information of fractional precision. This motion information of fractional precision may be, for example, a displacement vector of fractional precision based on the motion vector of integer precision. Specifically, for example, as a displacement vector of ½ precision, each of the x, y, and z coordinate values may be limited to take only one of {½, 0, −½}. An example of a motion compensation method with fractional precision will be described with reference to FIG. 3 described above. In FIG. 3, Bp means a region to be coded (for example, a region having a size of 16×16×16) in the frame, Brs means a reference region specified by a motion vector (=integer precision motion vector+fractional precision displacement vector) in the reconstructed point cloud of the reference frame at a fractional precision position interpolated by the interpolation unit 1023, and BrMCs means a reference region on which motion compensation is performed.

(Step S1) First, Brs is motion-compensated with a temporary motion vector to generate BrMCs. The temporary motion vector is obtained by adding a displacement vector of temporary fractional precision (for example, ½ for all of the x, y, and z coordinates) to the motion vector of integer precision derived by the integer precision motion estimation unit 10211.

(Step S2) Next, a point with the smallest distance in BrMCs is specified for each point in Bp.

(Step S3) The attribute value of the point in BrMCs specified in step S3 is set as a predicted value of the attribute value of the point in Bp.

(Step S4) The difference (predicted residual) between the attribute value of the point in Bp and the predicted value is calculated.

(Step S5) A cost value obtained by integrating the predicted residuals at all points in Bp is calculated. For example, the cost value may be the absolute error sum of the residuals. As another example, the sum of the squared errors of the residuals may be used.

(Step S6) The procedures of (step S1) to (step S5) described above are executed for all combinations of coordinate values that can be acquired in the temporary fractional precision displacement vector (in a case where each of the x, y, and z coordinate values takes only one of {½, 0, −½} (3×3=27 ways) to adopt a fractional precision displacement vector with the smallest cost value.

The prediction unit 1022 uses the motion information generated by the motion estimation unit 1021, the reconstructed point cloud of the frame output from the geometric information coding unit 101, and the reconstructed point cloud of the reference frame at a fractional precision position interpolated by the interpolation unit 1023 as inputs, and generates a predicted value of the attribute information of each point in the reconstructed point cloud of the frame. A method of generating a predicted value can be derived, for example, by the same procedure as (step S1) to (step S3) described above on the basis of the motion information determined by the motion estimation unit 1021.

The interpolation unit 1023 uses the reconstructed point cloud of an already coded frame stored in the frame buffer 104 as an input, interpolates the point at the fractional precision position (in other words, performs so-called super-resolution processing), and generates the reconstructed point cloud of the reference frame at the fractional precision position. An example of a specific interpolation method will be described with reference to FIG. 1A described above. The yellow points in FIG. 1A are points at integer precision positions (all coordinate values are integer values), and the orange points are points at fractional precision positions. Here, a case of interpolating points at ½ precision positions (positions where at least one of x, y, and z coordinates is an integer+0.5) from points at integer precision positions will be described as an example. As shown in FIGS. 1B to 1D, two points at the integer position closest to the point at each ½ precision position are specified, and in a case where there are the two points, the attribute information of the point at the ½ precision position is interpolated by calculating the average value of the attribute values of the two points. In addition, in a case where there are three or more points at the closest integer position, that is, a case where there are a plurality of combinations of “two points at the closest integer position,” the average value of the attribute information is first calculated for each combination, and then the average value of those points is further taken to obtain the final attribute value at the ½ precision position.

The entropy coding unit 1024 uses the difference (predicted residual) between the reconstructed point cloud of the frame output from the geometric information coding unit 101 and the predicted value calculated by the prediction unit 1022, and the motion information generated by the motion estimation unit 1021 (for example, the motion vector of integer precision and the displacement vector of fractional precision) as inputs, performs entropy coding, and generates a bit stream of the attribute information.

### (Point Cloud Decoding Device 200)

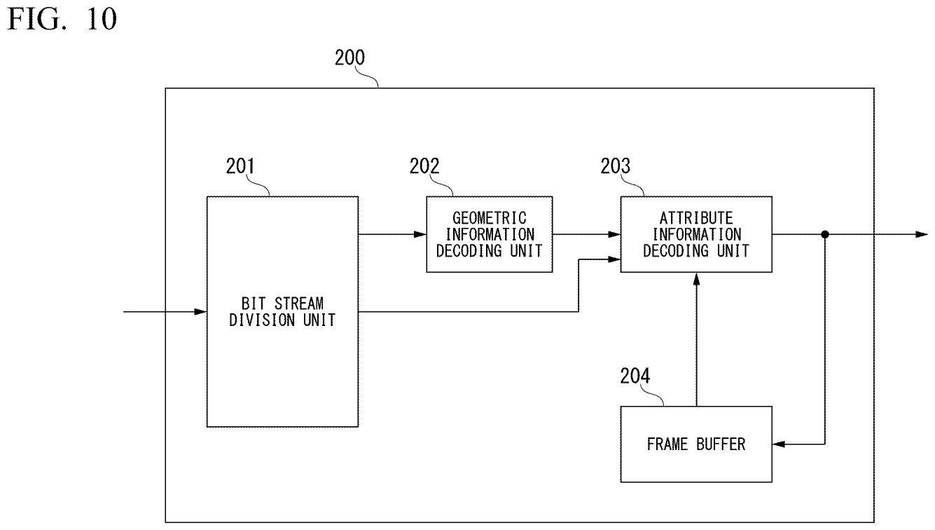

Hereinafter, the point cloud decoding device 200 according to the present embodiment will be described with reference to FIG. 10.

FIG. 10 is a diagram illustrating an example of a functional block of the point cloud decoding device 200 according to the present embodiment. As shown in FIG. 10, the point cloud decoding device 200 includes a bit stream division unit 201, a geometric information decoding unit 202, an attribute information decoding unit 203, and a frame buffer 204.

The bit stream division unit 201 uses the bit stream output from the point cloud coding device 100 as an input and divides the bit stream into a bit stream of the geometric information and a bit stream of the attribute information. The bit stream of the geometric information is output to the geometric information decoding unit 202, and the bit stream of the attribute information is output to the attribute information decoding unit 203.

The geometric information decoding unit 202 uses the bit stream of the geometric information output from the bit stream division unit 201 as an input, decodes the geometric information, and generates a reconstructed point cloud. At this point in time, each point in the reconstructed point cloud has only geometric information. A specific decoding method can be realized using a known method such as G-PCC, and thus the details thereof will be omitted. The reconstructed point cloud of only geometric information is output to the attribute information decoding unit 203.

In the following description, a value obtained by a decoding operation is also referred to as the decoding value.

The attribute information decoding unit 203 uses the bit stream of the attribute information output from the bit stream division unit 201, the reconstructed point cloud of only geometric information output from the geometric information decoding unit 202, and the reconstructed point cloud of the decoded frame stored in the frame buffer 204 as inputs, decodes attribute information (for example, color information) of each point in the reconstructed point cloud from the bit stream of the attribute information, and outputs the reconstructed point cloud of the frame.

The frame buffer 204 stores the reconstructed point cloud of the frame output from the attribute information decoding unit 203 and outputs the stored reconstructed point cloud to the attribute information decoding unit 203 during a process of decoding a frame to be decoded after the frame.

### (Attribute Information Decoding Unit 203)

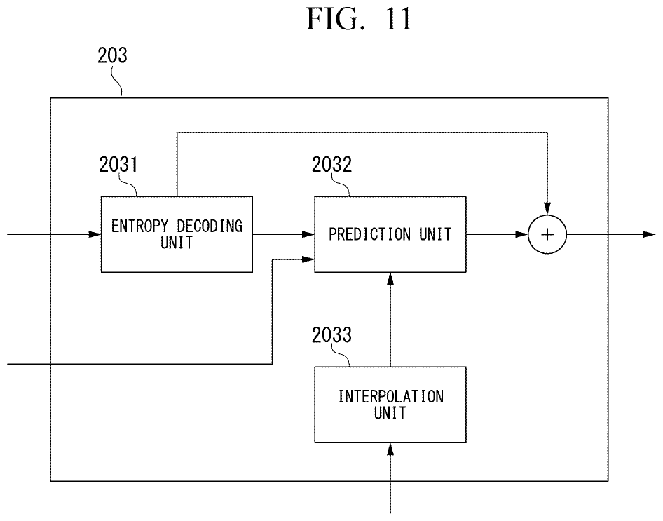

Hereinafter, the attribute information decoding unit 203 according to the present embodiment will be described with reference to FIG. 11.

FIG. 11 is a diagram illustrating an example of a functional block of the attribute information decoding unit 203 according to the present embodiment. As shown in FIG. 11, the attribute information decoding unit 203 includes an entropy decoding unit 2031, a prediction unit 2032, and an interpolation unit 2033.

The entropy decoding unit uses the bit stream of the attribute information generated by the bit stream division unit 201 as an input and decodes the predicted residual and motion information.

The prediction unit 2032 uses the reconstructed point cloud of only the geometric information generated by the geometric information decoding unit 202 and the motion information decoded by the entropy decoding unit as inputs, and derives the predicted value of the attribute value of each point in the reconstructed point cloud of only the geometric information. A method of deriving the predicted value can be calculated using, for example, the same method as in the prediction unit 1022.

The interpolation unit 2033 uses the reconstructed point cloud of an already coded frame stored in the frame buffer 204 as an input, interpolates the point at the fractional precision position (in other words, performs so-called super-resolution processing), and generates the reconstructed point cloud of the reference frame at the fractional precision position. Specific processing can be realized by the same processing as the interpolation unit 1023.

The predicted value generated by the prediction unit 2032 and the predicted residual decoded by the entropy decoding unit 2031 are added to generate a reconstructed point cloud of the frame.

The point cloud coding device 100 and the point cloud decoding device 200 described above may be realized as programs for causing a computer to execute each function (each step).

Meanwhile, although the application of the present invention to the point cloud coding device 100 and the point cloud decoding device 200 has been described as an example in each of the embodiments, the present invention is not limited to such an example, and can also be similarly applied to a point cloud coding/decoding system having each function of the point cloud coding device 100 and the point cloud decoding device 200.

According to the point cloud coding device 100 or the point cloud decoding device 200 of the present embodiment, it is possible to improve prediction performance and to enhance coding efficiency by performing motion compensation with fractional voxel precision.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

In addition, a computer program for realizing the function of each device described above may be recorded in a computer readable recording medium, and the program recorded in this recording medium may be read and executed by a computer system. Meanwhile, the term “computer system” referred to here may include an OS a hardware such as peripheral devices.

In addition, the term “computer readable recording medium” refers to a writable non-volatile memory such as a flexible disk, a magnetooptic disc, a ROM, or a flash memory, a portable medium such as a digital versatile disc (DVD), or a storage device such as a hard disk built into the computer system.

Further, the “computer readable recording medium” is assumed to include recording mediums that hold a program for a certain period of time like a volatile memory (for example, a dynamic random-access memory (DRAM)) inside a computer system serving as a server or a client in a case where a program is transmitted through networks such as the Internet or communication lines such as a telephone line.

In addition, the above-mentioned program may be transmitted from a computer system having this program stored in a storage device or the like through a transmission medium or through transmitted waves in the transmission medium to other computer systems. Here, the “transmission medium” that transmits a program refers to a medium having a function of transmitting information like networks (communication networks) such as the Internet or communication channels (communication lines) such as a telephone line.

In addition, the above-mentioned program may realize a portion of the above-mentioned functions.

Further, the program may be a so-called difference file (difference program) capable of realizing the above-mentioned functions by a combination with a program which is already recorded in a computer system.

### EXPLANATION OF REFERENCES

10 Point cloud processing system
100 Point cloud coding device
101 Geometric information coding unit
102 Attribute information coding unit
103 Local decoding unit
104 Frame buffer
105 Bit stream integration unit
200 Point cloud decoding device
201 Bit stream division unit
202 Geometric information decoding unit
203 Attribute information decoding unit
204 Frame buffer
1021 Motion estimation unit
1022 Prediction unit
1023 Interpolation unit
1024 Entropy coding unit
2031 Entropy decoding unit
2032 Prediction unit
2033 Interpolation unit

What is claimed is:

1. A point cloud coding device comprising:
an interpolation unit configured to perform an interpolation process on a reconstructed point cloud of a coded frame with respect to attribute information indicating an attribute of a point cloud and generate a reference frame of fractional precision;
a motion estimation unit configured to perform motion estimation between the reference frame of fractional precision and the frame of integer precision to generate motion information;
a prediction unit configured to generate a predicted value on the basis of the motion information; and
an entropy coding unit configured to entropy-code a difference between a point cloud of the frame and the predicted value.

2. The point cloud coding device according to claim 1, wherein the interpolation unit generates an interpolated value by performing an interpolation process on attribute values on the basis of attribute values of two closest points with respect to each fractional precision position.

3. The point cloud coding device according to claim 2, wherein, in a case where there are two or more of the interpolated values with respect to each fractional precision position, the interpolation unit uses an average value thereof as a final interpolated value.

4. The point cloud coding device according to claim 1, wherein the prediction unit uses, as a predicted value, an attribute value of a closest point with respect to each point in the frame of integer precision among points of a reference frame of fractional precision after motion compensation based on the motion information.

5. The point cloud coding device according to claim 1, wherein the fractional precision is ½ voxel precision.

6. A point cloud decoding device comprising:
an interpolation unit configured to perform an interpolation process on a reconstructed point cloud of a decoded frame with respect to attribute information in point cloud information and generate a reference frame of fractional precision;
an entropy decoding unit configured to decode motion information and a predicted residual from a bit stream;
a prediction unit configured to generate a predicted value on the basis of the motion information and the reference frame of fractional precision; and
an attribute information decoding unit configured to use a sum of the predicted residual and the predicted value as a decoding value of an attribute value.

7. The point cloud decoding device according to claim 6, wherein the interpolation unit generates an interpolated value by performing an interpolation process on attribute values on the basis of attribute values of two closest points with respect to each fractional precision position.

8. The point cloud decoding device according to claim 7, wherein, in a case where there are two or more of the interpolated values with respect to each fractional precision position, the interpolation unit uses an average value thereof as a final interpolated value.

9. The point cloud decoding device according to claim 6, wherein the prediction unit uses, as a predicted value, an attribute value of a closest point with respect to each point in the frame of integer precision among points of a reference frame of fractional precision after motion compensation based on the motion information.

10. The point cloud decoding device according to claim 6, wherein the fractional precision is ½ voxel precision.

11. A point cloud coding method comprising:
performing an interpolation process on a reconstructed point cloud of a coded frame with respect to attribute information in point cloud information and generating a reference frame of fractional precision;
performing motion estimation between the reference frame of fractional precision and the frame of integer precision to generate motion information;
generating a predicted value on the basis of the motion information; and
entropy-coding a difference between a point cloud of the frame and the predicted value.

12. A program for causing a computer included in a point cloud coding device to execute:
performing an interpolation process on a reconstructed point cloud of a coded frame with respect to attribute information in point cloud information and generating a reference frame of fractional precision;
performing motion estimation between the reference frame of fractional precision and the frame of integer precision to generate motion information;
generating a predicted value on the basis of the motion information; and
entropy-coding a difference between a point cloud of the frame and the predicted value.

13. A point cloud decoding method comprising:
performing an interpolation process on a reconstructed point cloud of a decoded frame with respect to attribute information in point cloud information and generating a reference frame of fractional precision;
decoding motion information and a predicted residual from a bit stream;
generating a predicted value on the basis of the motion information and the reference frame of fractional precision; and
using a sum of the predicted residual and the predicted value as a decoding value of an attribute value.

14. A program for causing a computer included in a point cloud decoding method to execute:
performing an interpolation process on a reconstructed point cloud of a decoded frame with respect to attribute information in point cloud information and generating a reference frame of fractional precision;
decoding motion information and a predicted residual from a bit stream;
generating a predicted value on the basis of the motion information and the reference frame of fractional precision; and
using a sum of the predicted residual and the predicted value as a decoding value of an attribute value.
